(19) United States
(12) Patent Application Publication
(10) Pub. No.: US 2017/0230492 A1
(43) Pub. Date: Aug. 10, 2017

(54) WEARABLE DEVICE AND METHOD OF CONTROLLING COMMUNICATION

(71) Applicant: SONY CORPORATION, TOKYO (JP)

(72) Inventors: HIROTAKA ISHIKAWA, KANAGAWA (JP); TAKESHI IWATSU, KANAGAWA (JP)

(21) Appl. No.: 15/118,470

(22) PCT Filed: Nov. 18, 2014
(86) PCT No.: PCT/JP2014/080543

§ 371 Date: Mar. 22, 2017

(30) Foreign Application Priority Data
Feb. 21, 2014 (JP) 2014-031603

(51) Int. Cl. H04M 1/60; H04B 1/3827; H04M 1/725

(52) U.S. Cl. CPC H04M 1/6066; H04M 1/7253; H04B 1/385; H04M 2250/02; H04B 2001/3866

(57) ABSTRACT

Voice data communication is performed appropriately depending on the purposes of use. Provided is a wearable device including a microphone (172), a speaker (174), an input voice data acquisition unit (510) configured to acquire input voice data from the microphone (174), an output voice data providing unit (520) configured to provide output voice data to the speaker (172), a communication unit (530) configured to perform communication sessions for allowing the input voice data and the output voice data to be transmitted and received in accordance with a hands-free profile of Bluetooth between the communication unit and a smartphone (200), and a controller (540) configured to invalidate a session triggered by the smartphone (200) among the communication sessions.

Representative Drawing

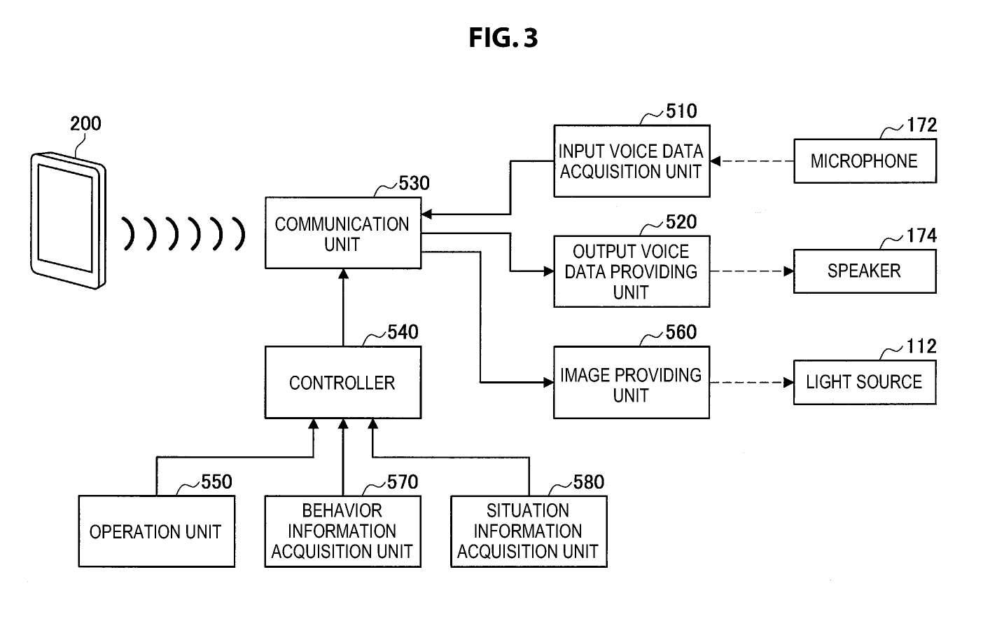

FIG. 3

### TECHNICAL FIELD

The present disclosure relates to a wearable device and a method of controlling communication.

### BACKGROUND ART

Hands-free profile (HFP) is provided as a profile (communication protocol) for Bluetooth (registered trademark) that is one of short-range wireless communication standards. The HFP is a protocol for voice communication between a mobile device (audio gateway) such as mobile phone equipped with a calling feature and a device (a hands-free unit) such as a headset and in-vehicle hands-free kit. The communication performed in accordance with the HFP makes it possible to respond to an incoming call to a mobile phone using a headset or in-vehicle hands-free kit, or to perform an outgoing call from a headset or in-vehicle hands-free kit through a mobile phone.

The technique using the HFP described above is disclosed in Patent Literatures 1 and 2, as an example. Patent Literature 1 discloses a call system using a mobile phone and hands-free kit, capable of switching from handset call to hands-free call at appropriate timing. In addition, Patent Literature 2 discloses an in-vehicle hands-free kit for allowing a user to recognize appropriately between incoming calls of a plurality of mobile phones when the mobile phones, which are simultaneously connected via the hands-free communication protocol, perform the respective incoming calls at the same time.

### CITATION LIST

### Patent Literature

Patent Literature 1: JP 2002-171337A

Patent Literature 2: JP 2009-284139A

### SUMMARY OF INVENTION

### Technical Problem

As described above, the HFP is applied not only to the in-vehicle hands-free kit disclosed in Patent Literatures 1 and 2 but also to the headset. The headset is one example of wearable devices that are mainly intended for a voice call. However, with the recent development of technology, various kinds of wearable devices have been developed in addition to a headset. One example of such wearable devices includes a wearable optical device intended to provide an image, such as a head-mounted display (HMD). In the wearable device intended to provide an image, the HFP is also used for transmission of a voice command as an example. However, when a wearable device is not necessarily intended for a voice call, the communication process performed in accordance with the HFP without modification sometimes does not necessarily lead to the improvement of usability.

Therefore, an embodiment of the present disclosure provides a novel and improved wearable device and method of controlling communication, allowing voice data communication to be performed appropriately depending on the purposes of use.

### SOLUTION TO PROBLEM

According to an embodiment of the present disclosure, there is provided a wearable device including a voice input unit, a voice output unit, an input voice data acquisition unit configured to acquire input voice data from the voice input unit, an output voice data providing unit configured to provide output voice data to the voice output unit, a communication unit configured to perform communication sessions for allowing the input voice data and the output voice data to be transmitted and received in accordance with a hands-free profile between the communication unit and an external device, and a controller configured to invalidate a session triggered by the external device among the communication sessions.

According to an embodiment of the present disclosure, there is provided a method of controlling communication between a wearable device and an external device, the method including performing communication sessions including a transmission of input voice data acquired from a voice input unit of the wearable device to the external device and a reception of output voice data to be provided to a voice output unit of the wearable device from the external device in accordance with a hands-free profile, and invalidating a session triggered by the external device among the communication sessions.

In the above configuration, among communication sessions for transmitting and receiving voice data between the wearable device and the external device, a session triggered by the external device is invalidated, but a session triggered by the wearable device is used. This may allow an incoming call of voice data to be unaccepted, but the transmission of voice data to be available. A response to the transmission of voice data can be received in the form of non-voice data.

### ADVANTAGEOUS EFFECTS OF INVENTION

According to the embodiments of the present disclosure described above, voice data communication can be performed appropriately depending on the purposes of use of the wearable device.

Note that the effects described above are not necessarily limited, and along with or instead of the effects, any effect that is desired to be introduced in the present specification or other effects that can be expected from the present specification may be exhibited.

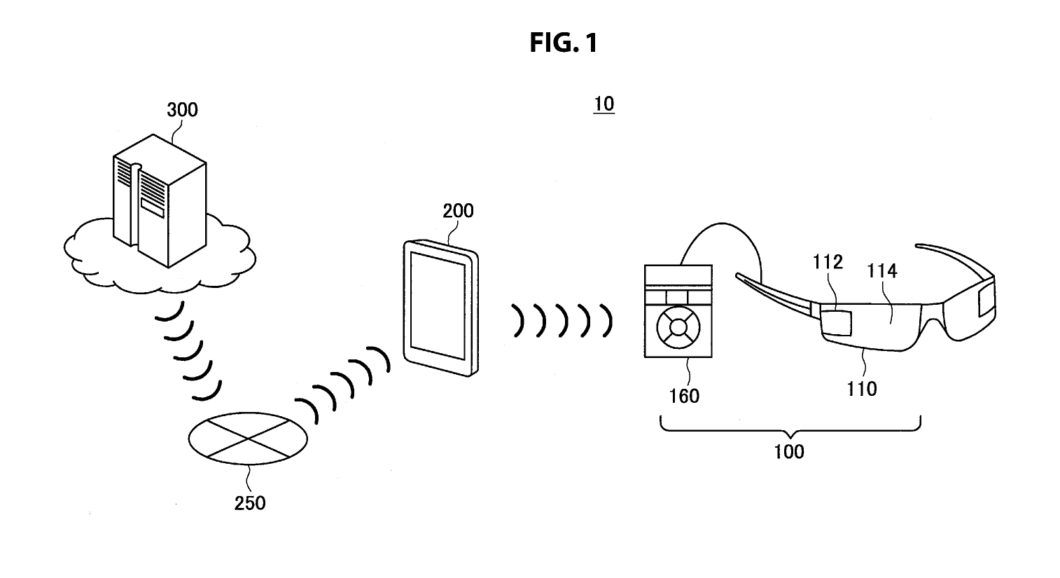

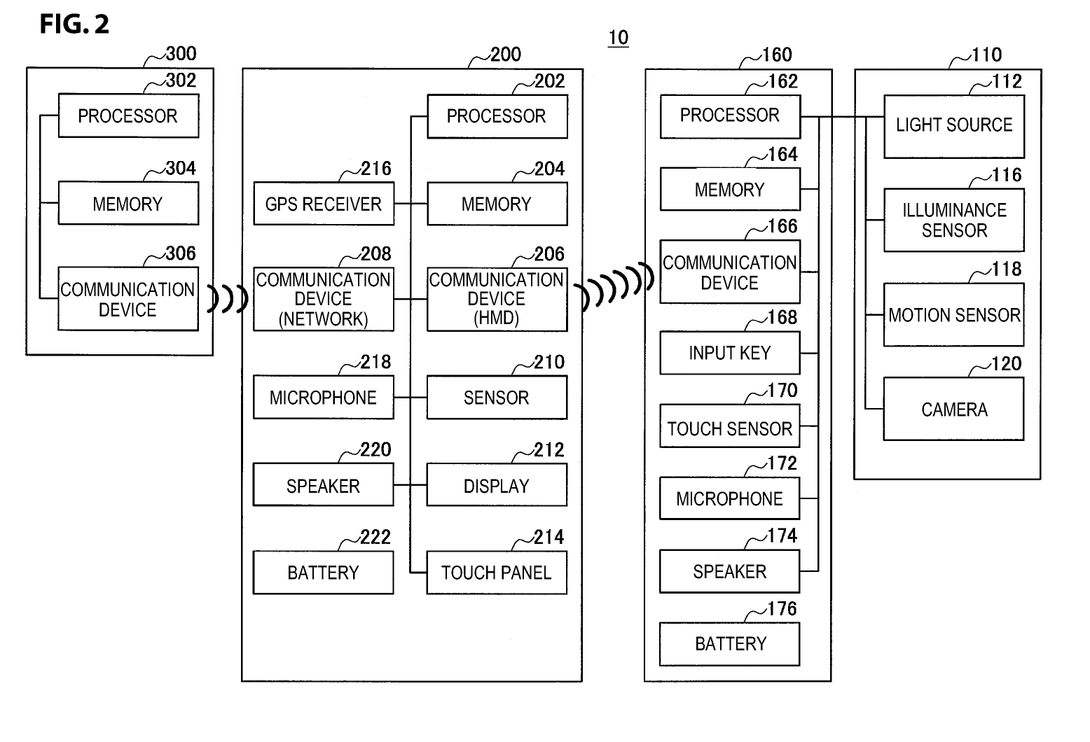

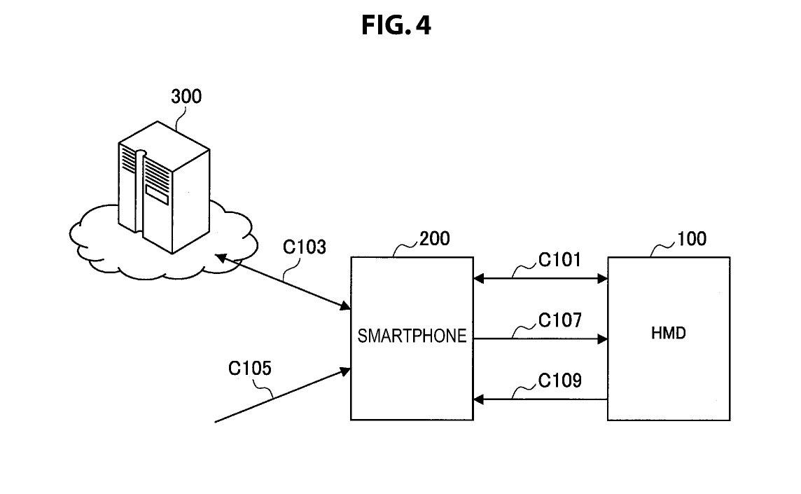

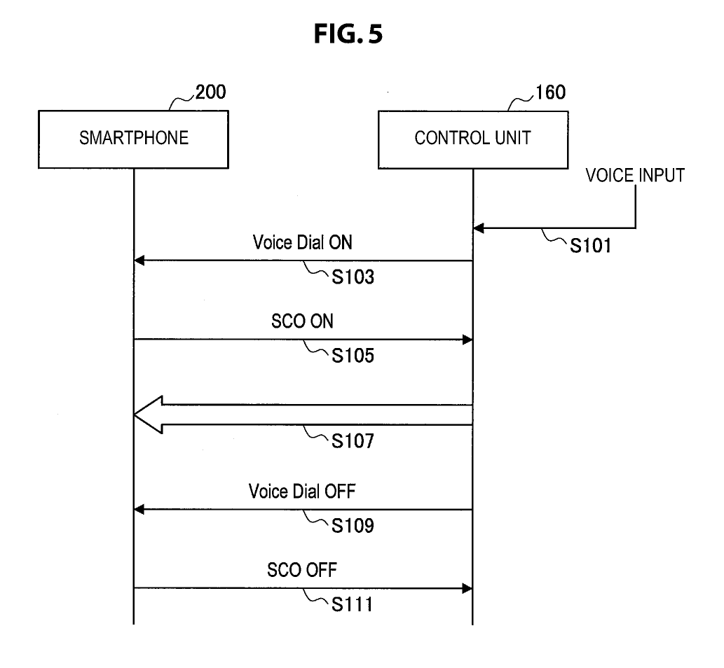

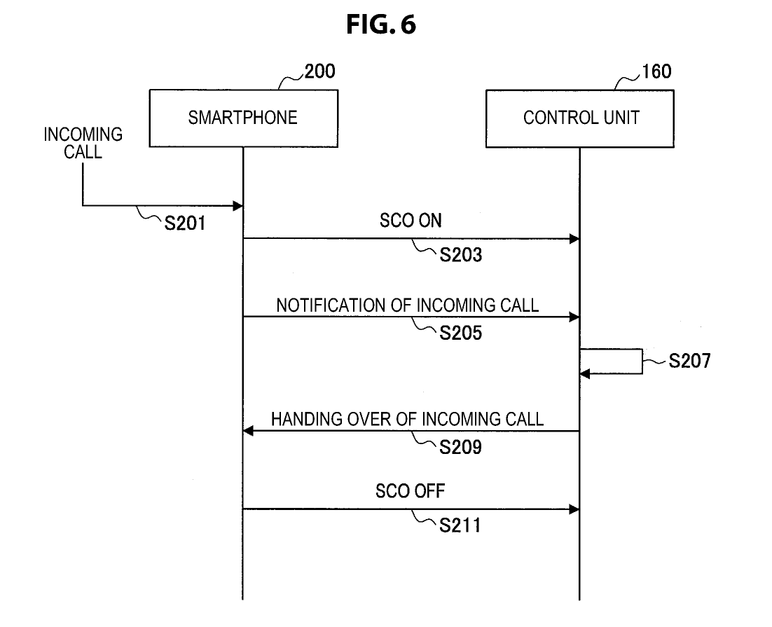

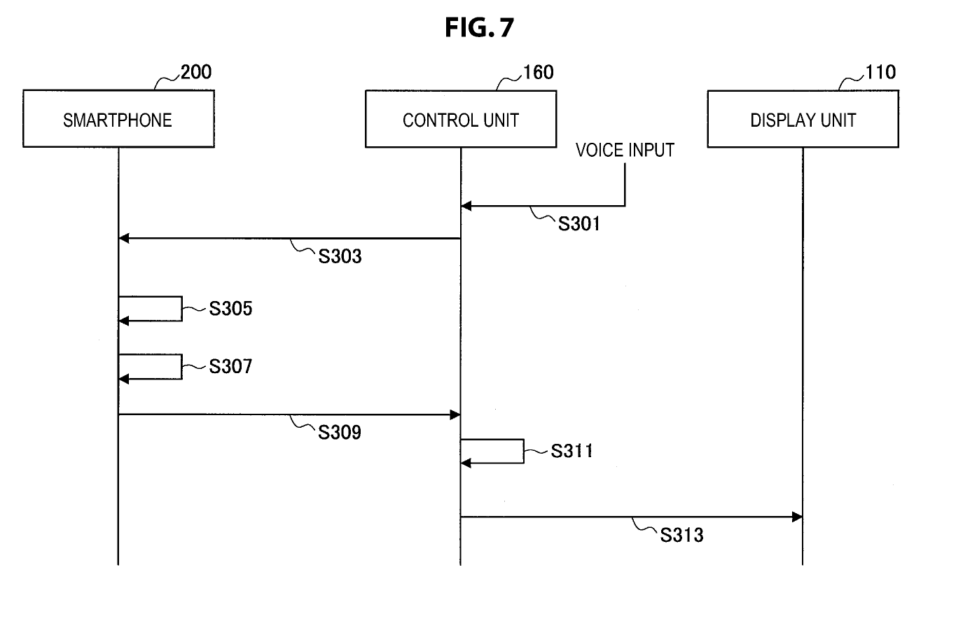

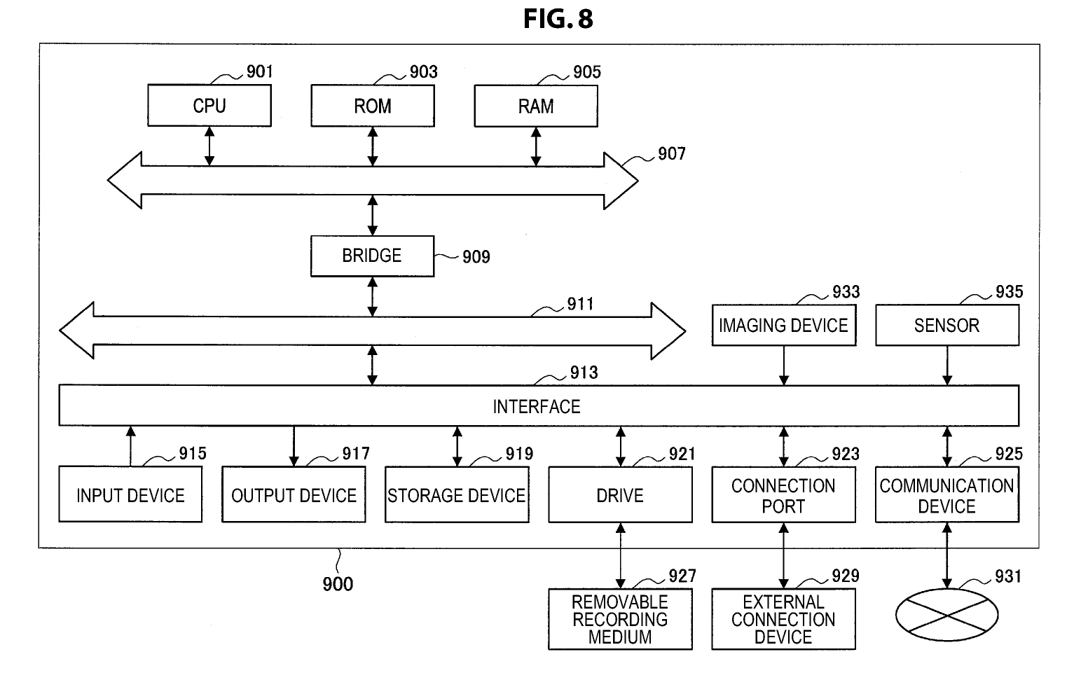

### BRIEF DESCRIPTION OF DRAWINGS

[FIG. 1] FIG. 1 is a diagram showing a schematic configuration of a system according to an embodiment of the present disclosure.

[FIG. 2] FIG. 2 is a block diagram showing a schematic functional configuration of the system shown in FIG. 1.

[FIG. 3] FIG. 3 is a block diagram showing a functional configuration for communication control of an HMD in an embodiment of the present disclosure.

[FIG. 4] FIG. 4 is a diagram illustrated to describe an overview of communication in an embodiment of the present disclosure.

[FIG. 5] FIG. 5 is a sequence diagram showing an example of a communication session when a voice input is acquired in the HMD in an embodiment of the present disclosure.

[FIG. 6] FIG. 6 is a sequence diagram showing an example of a communication session when an incoming call is made in a smartphone in an embodiment of the present disclosure.

[FIG. 7] FIG. 7 is a sequence diagram showing an example of a communication session in a system according to an embodiment of the present disclosure.

[FIG. 8] FIG. 8 is a block diagram showing an example of a hardware configuration of an electronic apparatus according to an embodiment of the present disclosure.

### DESCRIPTION OF EMBODIMENT(S)

Hereinafter, (a) preferred embodiment(s) of the present disclosure will be described in detail with reference to the appended drawings. In this specification and the drawings, elements that have substantially the same function and structure are denoted with the same reference signs, and repeated explanation is omitted.

The description will be given in the following order.

1. System Configuration

2. Communication Control in HMD
2-1. Functional Configuration
2-2. Overview
2-3. Example of Communication Session

3. Hardware Configuration

4. Supplement

### (1-1. System Configuration)

FIG. 1 is a diagram showing a schematic configuration of a system according to an embodiment of the present disclosure. FIG. 2 is a block diagram showing a schematic functional configuration of the system shown in FIG. 1. Referring to FIGS. 1 and 2, the system 10 includes a head-mounted display (HMD) 100, a smartphone 200, and a server 300. Hereinbelow, configurations of the respective devices will be described.

(Head-mounted display)

The HMD 100 includes a display unit 110 and a control unit 160. The display unit 110 has a housing in the shape of, for example, glasses, and is worn by a user (observer) on his or her head. The control unit 160 is connected to the display unit 110 by a cable.

The display unit 110 is provided with a light source 112 and a light guide plate 114 as shown in FIG. 1. The light source 112 emits image display light according to control of the control unit 160. The light guide plate 114 guides the image display light incident from the light source 112, and then emits the image display light to a position corresponding to the eyes of the user. The eyes of the user receive incidence of light that is incident on the light guide plate 114 from a real space and is then transmitted through the light guide plate 114, and the image display light guided from the light source 112 by the light guide plate 114. Accordingly, the user wearing the display unit 110 can perceive an image being superimposed on the real space. Note that, for the configuration for causing the image display light to be emitted from the light source 112 through the light guide plate 114, for example, the technology disclosed in JP4776285B may be used. The display unit 110 may be further provided with an optical system that is not illustrated for the configuration.

Furthermore, the display unit 110 may be provided with an illuminance sensor 116, a motion sensor 118, and/or a camera 120, as shown in FIG. 2. The illuminance sensor 116 detects the illuminance of light that is incident on the display unit 110. The motion sensor 118 includes a three-axis acceleration sensor, a three-axis gyro sensor, and a three-axial geomagnetic sensor, as an example. The camera 120 captures an image in the real space. The image captured by the camera 120 is regarded as an image corresponding to the field of view of the user in the real space.

The control unit 160 is provided with a processor 162, a memory 164, a communication device 166, an input key 168, a touch sensor 170, a microphone 172, a speaker 174, and a battery 176. The processor 162 operates according to programs stored in the memory 164 to provide various functions. The function of an input voice data acquisition unit, an output voice data acquisition unit, a controller, or the like, which will be described later, is implemented by the processor 162, as one example. The processor 162 transmits control signals to the display unit 110 in wired communication through a cable, and provides power for the light source 112 and the motion sensor 118.

The memory 164 stores various kinds of data for operations of the processor 162. For example, the memory 164 stores programs for the processor 162 to realize various functions. In addition, the memory 164 temporarily stores data output from the illuminance sensor 116, the motion sensor 118 and/or the camera 120 of the display unit 110. The communication device 166 executes wireless communication with the smartphone 200. For the wireless communication, for example, Bluetooth (a registered trademark), Wi-Fi, or the like is used. As described later, in the present embodiment, the communication device 166 is capable of communicating with the smartphone 200 in accordance with the hands-free profile (HFP) of Bluetooth (registered trademark). The input key 168 includes, for example, a return key, a Push-to-Talk (PTT) key, and the like, and acquires user operations with respect to the HMD 100. The touch sensor 170 likewise acquires user operations with respect to the HMD 100. To be more specific, the touch sensor 170 acquires, for example, operations such as tapping, swiping and the like performed by a user.

The microphone 172 converts sound into an electrical signal (input voice data) and provides it to the processor 162. The speaker 174 converts an electrical signal (output voice data) provided from the processor 162 into sound. In the present embodiment, the microphone 172 and the speaker 174 function as a voice input unit and a voice output unit of the HMD 100, respectively. The battery 176 supplies power to all the components of the control unit 160 and the display unit 110.

Note that a small size and light weight of the display unit 110 are intended in the HMD 100 such that the processor 162, the microphone 172, the speaker 174, the battery 176, and the like can be mounted in the control unit 160, and the display unit 110 and the control unit 160 are separated from each other, but connected with a cable. Since the control unit 160 is also carried by a user, it is desirable that it be as small and light as possible. Thus, by setting the functions realized by the processor 162 as minimum functions for controlling the display unit 110 and other functions to be realized by the smartphone 200, for example, a small size of the entire control unit 160 and battery 176 attributable to a reduction in power consumption of the processor 162 may also be attempted.

### (Smartphone)

The smartphone 200 is provided with a processor 202, a memory 204, communication devices 206 and 208, a sensor 210, a display 212, a touch panel 214, a Global Positioning System (GPS) receiver 216, a microphone 218, a speaker 220, and a battery 222. The processor 202 realizes various functions as it operates according to programs stored in the memory 204. As described above, as the processor 202 realizes various functions in cooperation with the processor 162 provided in the control unit 160 of the HMD 100, the control unit 160 can be small and light. The memory 204 stores various kinds of data for operations of the smartphone 200. For example, the memory 204 stores programs for the processor 202 to realize the various functions. In addition, the memory 204 temporarily or permanently stores data acquired by the sensor 210 and the GPS receiver 216 and data transmitted to and received from the HMD 100.

The communication device 206 executes wireless communication using Bluetooth (a registered trademark), Wi-Fi, or the like with the communication device 166 provided in the control unit 160 of the HMD 100. In the present embodiment, the communication device 206 is capable of communicating with the communication device 166 of the HMD 100 in accordance with the HFP of Bluetooth (registered trademark). On the other hand, the communication device 208 performs the communication via network through a mobile telephone network 250 or the like. More specifically, the communication device 208 performs a voice call with another telephone performs data communication with the server 300 via the mobile telephone network 250. This allows the smartphone 200 to provide a calling feature. The display 212 displays various images according to control of the processor 202. The touch panel 214 is disposed on the display 212, and acquires touch operations of the user with respect to the display 212. The GPS receiver 216 receives GPS signals for measuring latitude, longitude, and altitude of the smartphone 200. The microphone 218 converts sounds into audio signals, and then provides the signals to the processor 202. The speaker 220 outputs sounds according to control of the processor 202. The battery 222 supplies power to the entire smartphone 200.

### (Server)

The server 300 is provided with a processor 302, a memory 304, and a communication device 306. Note that the server 300 is realized, for example, through cooperation between a plurality of server devices on a network; however, it will be described as a virtual single device herein for simplification of description. The processor 302 realizes various functions as it operates according to programs stored in the memory 304. The processor 302 of the server 300 executes various information processes according to, for example, requests received from the smartphone 200, and transmits results thereof to the smartphone 200. The memory 304 stores various kinds of data for operations of the server 300. For example, the memory 304 stores programs for the processor 302 to realize the various functions. Further, the memory 304 may temporarily or continuously store data uploaded from the smartphone 200. The communication device 306 executes network communication via, for example, a mobile telephone network 250 with the smartphone 200.

Hereinabove, the system configuration according to an embodiment of the present disclosure has been described. Note that, in the present embodiment, the HMD 100 is an example of the wearable device. As described above, the HMD 100 makes an observer perceive images by guiding image display light to the eyes of the observer using the light guide plate 114. Thus, although the term “display” is used, the HMD 100 is not necessarily a device that causes images to be formed on its display plane. Of course, an HMD of another known type such as a type of HMD in which images are formed on its display plane may be used instead of the HMD 100. Although the HMD 100 is exemplified as the wearable device in the above description, the wearable device according to an embodiment of the present disclosure is not limited to such example, but may be worn on any part of the body other than the user's head, such as wrist (wristwatch type), arm (arm band type), waist (belt type).

In addition, the system configuration described above is an example, and various other system configurations are also possible. For example, the HMD 100 may not necessarily have the display unit 110 and the control unit 160 separated from each other, and the entire configuration of the HMD 100 described above may be consolidated in a glasses-type housing such as the display unit 110. In addition, as described above, at least some of the functions for controlling the HMD 100 may be realized by the smartphone 200. Alternatively, the display unit 110 may also be provided with a processor and thus information processing of the HMD 100 may be realized in cooperation between the processor 162 of the control unit 160 and the processor of the display unit 110.

As another modified example, the system 10 may not include the smartphone 200, and communication may be directly executed between the HMD 100, and the server 300. In addition, in the system 10, the smartphone 200 may be replaced by another device that can execute communication and a voice call with the HMD 100, and can execute communication with the server 300, for example, a tablet terminal, a personal computer, a portable game device, or the like.

### (2. Communication Control in HMD)

### (2-1. Functional Configuration)

FIG. 3 is a block diagram showing a functional configuration for communication control of an HMD in an embodiment of the present disclosure. Referring to FIG. 3, in the present embodiment, the functional configuration for communication control of the HMD includes an input voice data acquisition unit 510, an output voice data providing unit 520, a communication unit 530, and a controller 540. The function configuration may further include an operation unit 550, an image providing unit 560, a behavior information acquisition unit 570, and/or a situation information acquisition unit 580.

In the system 10, these functional components are implemented in the control unit 160 of the HMD 100 as an example. In this case, the communication unit 530 is implemented as the communication device 166, and the operation unit 550 is implemented as the input key 168 and the touch sensor 170. In addition, other functional components are implemented by the processor 162 that operates in accordance with a program stored in the memory 164. The respective functional components will be further described below.

The input voice data acquisition unit 510 acquires input voice data from the microphone 172. As described above, in the present embodiment, the microphone 172 included in the control unit 160 functions as a voice input unit of the HMD 100. In another embodiment, a microphone included in the display unit 110 may function as the voice input unit. Alternatively, an external microphone that is connected to a connector included in the display unit 110 or the control unit 160 may function as the voice input unit.

In the present embodiment, input voice data acquired by the input voice data acquisition unit 510 is interpreted as a command, a search keyword, or the like, as an example. Thus, the input voice data acquisition unit 510 initiates the acquisition of the input voice data when a predetermined user operation (e.g., depression of a PTT key included in the input key 168) acquired by the operation unit 550 is initiated. Furthermore, the input voice data acquisition unit 510 may terminate the acquisition of the input voice data when the user's operation is terminated, and may provide the acquired input voice data to the controller 540. The input voice data may contain a spoken voice of the user.

The output voice data providing unit 520 provides output voice data to the speaker 174. As described above, in the present embodiment, the speaker 174 included in the control unit 160 functions as a voice output unit of the HMD 100. In another embodiment, a speaker or earphone included in the display unit 110 may function as the voice output unit. Alternatively, an external speaker or earphone, which is connected to a connector included in the display unit 110 or the control unit 160 may function as the voice output unit. The above description exemplifies a speaker or earphone as the voice output unit, an example of the voice output unit according to an embodiment of the present disclosure includes, but is not limited to the above example, a headphone or bone conduction vibrator having one or a plurality of earphones coupled to it using a headband.

The communication unit 530 performs a communication session for allowing the input voice data and output voice data to be transmitted and received respectively in accordance with the hands-free profile (HFP) between the communication unit 530 and an external device. The input voice data to be transmitted by the communication unit 530 is acquired from the microphone 172 by the input voice data acquisition unit 510. In addition, the output voice data to be received by the communication unit 530 is provided to the speaker 174 by the output voice data providing unit 520. As described above, in the present embodiment, the communication device 166 that implements the communication unit 530 communicates with the smartphone 200 in accordance with the HFP of Bluetooth (registered trademark).

The communication unit 530 performs a communication session using another protocol of Bluetooth (registered trademark) or another communication standard such as Wi-Fi between the communication unit 530 and the smartphone 200. In this communication session, as one example, data used to generate image data provided by the image providing unit 560 is received. In addition, in this communication session, information for setting the HMD 100 may be received.

The controller 540 controls the respective functional components including the communication unit 530. As one example, when the input voice data acquisition unit 510 acquires the input voice data, the controller 540 controls the communication 530 so that the communication unit 530 initiates a communication session with the smartphone 200 in accordance with the HFP. On the other hand, when the communication session with the smartphone 200 in accordance with the HFP (also referred to as “HFP session” hereinafter) is triggered by the smartphone 200, the controller 540 invalidates the HFP session. More specifically, when the HFP session is triggered by an incoming call to the smartphone 200 as an example, the controller 540 ignores the received data (controlling the output voice data providing unit 520 to prevent the output voice data providing unit 520 from providing voice data to the speaker 174), and controls the communication unit 530 so that the communication unit 530 transmits a command for handing over the incoming call to the smartphone 200. When the HFP session is triggered by factors other than the incoming call, the controller 540 may simply ignore the received voice data and terminate the communication session, thereby invalidating the communication session. The control of the communication unit 530 by the controller 540 will be described in detail later.

The controller 540 may determine whether to invalidate the HFP session triggered by the smartphone 200 on the basis of information provided from the operation unit 550, the behavior information acquisition unit 570, and/or the situation information acquisition unit 580. This will be described later with reference to a description of their respective functional components. In addition, controller 540 may determine whether to invalidate the HFP session triggered by the smartphone 200 on the basis of the setting information received from the smartphone 200 by the communication unit 530.

The controller 540 does not invalidate a communication session using another protocol of Bluetooth (registered trademark) or another communication standard such as Wi-Fi. As one example, when the communication unit 530 receives data used to generate image data from the smartphone 200, the controller 540 controls the image providing unit 560 so that the image providing unit 560 generates the image data on the basis of the received data and provides the generated image data to the light source 112 of the display unit 110.

The operation unit 550 acquires various user operations on the HMD 100. The operation unit 550 may acquire, as the user operation, a command assigned to the operation on the input key 168 or the touch sensor. The operation unit 550 may acquire, as the user operation, a command inputted on the graphical user interface (GUI) using an image provided in the display unit 110 in conjunction with the image providing unit 560. The user operation acquired through the operation unit 550 (e.g., the input key 168) may be used as a trigger that allows the input voice data acquisition unit 510 to initiate acquisition of input voice data.

As an additional configuration, the controller 540 may determine whether to invalidate the HFP session triggered by the smartphone 200 on the basis of the user operation acquired by the operation unit 550. In this case, as one example, when the HFP session is triggered by an incoming call to the smartphone 200 and the communication unit 530 receives data, a dialog for inquiring whether to respond to the incoming call is outputted in the HMD 100 as an image from the light source 112 via the image providing unit 560. The operation unit 550 acquires a user operation on the dialog (response or non-response), and the controller 540 determine whether to invalidate the HFP session on the basis of the acquired user operation. Alternatively, the user may register previously the determination of whether to invalidate the HFP session as the setting information using the operation unit 550.

The image providing unit 560 provides the image data to the light source 112 of the display unit 110. The image data is generated on the basis of the data received by the communication unit 530 from the smartphone 200. The image data may be generated on the basis of the data stored previously in the memory 164 of the HMD 100. The image to be generated includes a picture of various application features provided by the smartphone 200 and a GUI used for operation or setting on the HMD 100.

The behavior information acquisition unit 570 acquires information indicating a behavior state of the user using the HMD 100. In the system 10, it is possible to acquire the information indicating a behavior state of the user by using, as a sensor, the motion sensor 118 included in the display unit 110 of the HMD 100 or the sensor 210 or the GPS receiver 216 included in the smartphone 200. Such behavior recognition technology is known as disclosed in JP 2010-198595A, JP 2011-081431A, JP 2012-008771A, or the like, and thus a detailed description thereof will be omitted. The behavior information acquisition unit 570 may acquire the information indicating a behavior state of the user by performing an analysis process on the basis of information obtained from the sensor included in the HMD 100, or may receive information obtained by an analysis process performed in the smartphone 200 or the server 300 through the communication unit 530.

As described above, as an additional configuration, the controller 540 may determine whether to invalidate the HFP session triggered by the smartphone 200 on the basis of the user's behavior state indicated by the information acquired by the behavior information acquisition unit 570. In this case, as one example, it is possible to consider a setting in which invalidation is not performed when the user is stationary but invalidation is performed when the user is moving. In addition, it is possible to consider a setting in which invalidation is not performed when the user is moving on foot but invalidation is performed when the user is riding in a vehicle (e.g., train, car, and bicycle).

The situation information acquisition unit 580 acquires information indicating a situation surrounding the HMD 100. In the HMD 100, the information indicating a situation surrounding the HMD 100 can be acquired by using, as a sensor, the illuminance sensor 116, the motion sensor 118, or the camera 120 included in the display unit 110 of the HMD 100 and the microphone 172 included in the control unit 160. As described above, as an additional configuration, on the basis of the situation surrounding the HMD 100 indicated by the information acquired by the situation information acquisition unit 580, the controller 540 may determine whether to invalidate the HFP session triggered by the smartphone 200. In this case, as one example, it is possible to consider a setting in which invalidation is not performed when the periphery is bright but invalidation is performed when the periphery is dark. In addition, it is possible to consider a setting in which invalidation is not performed when the HMD 100 is installed properly (e.g., this is determined on the basis of a result obtained from the detection by the motion sensor 118), otherwise invalidation is performed. In addition, it is possible to consider a setting in which invalidation is not performed when the periphery is quiet but invalidation is performed when the periphery is noisy.

The determination of whether to invalidate the HFP session and a condition that the invalidation is to be performed on the basis of the information acquired by the behavior information acquisition unit 570 or the situation information acquisition unit 580 as described above can be switched and set by the user operation acquired through the operation unit 550.

### (2-2. Overview)

An overview of communication in the present embodiment is described with reference to FIG. 4. FIG. 4 illustrates communications C101 to C109 performed in the system 10.

The communication C101 is performed between the HMD 100 and the smartphone 200 when the HMD 100 acquires a voice input. In the communication C101, the input voice data acquired in the HMD 100 is transmitted to the smartphone 200. The communication C101 is performed in accordance with the HFP of Bluetooth (registered trademark) described above as an example. The voice input in the HMD 100 is used to input a command, a search keyword, a normal text, or the like.

The communication C103 is data communication between the smartphone 200 and the server 300, which is performed by the smartphone 200 on the basis of the input voice data acquired from the HMD 100. As one example, the smartphone 200 transmits the input voice data to the server 300, and the processor 320 of the server 300 performs a voice recognition process on the input voice data. The server 300 sends back a text obtained by the voice recognition to the smartphone 200. The smartphone 200 interprets the received text as a command, a search keyword, a normal text, or the like, depending on a feature that is activated in the HMD 100, and performs a predetermined process. Even when the process is performed, the smartphone 200 may communicate with the server 300. The smartphone 200 transmits a result obtained by performing the process to the HMD 100.

The communication C105 is an incoming call directed to the smartphone 200. As described above, the smartphone 200 has a calling feature. Thus, a call is directed from another telephone or information processing terminal to the smartphone 200 via the mobile telephone network 250 or the like (incoming call).

The communication C107 is set up between the smartphone 200 and the HMD 100 when the smartphone 200 receives an incoming call. The smartphone 200 and the HMD 100 are configured to set to perform communication in accordance with the HFP. In the HFP specification, when the smartphone 200 (audio gateway) receives an incoming call, the communication session is set up in such a way that the HMD 100 (a hands-free unit) can receive the incoming call. The communication C107 is triggered by the smartphone 200 due to such specification.

In the communication C109, the HMD 100 does not receive the incoming call but hands it over to the smartphone 200 in spite of setting up the communication session by the smartphone 200 in the communication C107. The HFP defines a command for the handover, and thus it is possible to perform the communication C109 in accordance with the HFP. Subsequently, this allows the incoming call to be processed on the side of the smartphone 200.

The reason why the communication control, particularly, in the communication C109 is performed as described above will be further described.

The HMD is mainly intended to output information as an image that is provided using the light source 112 and the light guide plate 114 of the display unit 110. In this respect, the speaker 174 included in the control unit 160 is an auxiliary output means. On the other hand, the HMD 100 has characteristics of the wearable device, and thus it is difficult to extend a hardware input means such as the input key 168 and the touch sensor 170. Thus, the voice input through the microphone 172 included in the control unit 160 is used in conjunction with the input through the input key 168 or the touch sensor 170.

In the above case, as a communication protocol suitable for the transmission of the input voice data acquired in the HMD 100 to the smartphone 200, the HFP is used between the HMD 100 and the smartphone 200 that communicate wirelessly over Bluetooth (registered trademark). In the HFP, in terms of specification, the communication session is set up not only when he HMD 100 acquires the input voice data but also when the smartphone 200 receives an incoming call, and the HMD 100 becomes capable of receiving the incoming call, which is as described above.

However, the speaker 174 is configured to serve as an auxiliary output means in the HMD 100, and further the microphone 172 is not designed to acquire a continuous voice input including a call. In addition, the HMD 100 according to the present embodiment is not provided in contact with the ear or mouth of the user, unlike a headset including an earphone or microphone provided in contact with the ear or mouth of the user. Thus, the user can respond to the incoming call by using the smartphone 200 while wearing the HMD 100.

In such a situation, responding to the incoming call using the HMD 100 does not necessarily improve the usability. Thus, it may be a best approach to use a communication protocol intended only to transmit the input voice data acquired by the HMD 100 to the smartphone 200, but the currently used Bluetooth (registered trademark) does not support such a protocol. In addition, a great deal of labor is necessary to create a communication protocol, and thus it is not practical to create a new communication protocol for the use of such a limited application like the HMD 100. Thus, it will be a practical solution to use the HFP when the input voice data acquired by the HMD 100 is transmitted to the smartphone 200.

In the present embodiment, in view of the circumstances as described above, a communication session that is triggered by the smartphone 200 among communication sessions in accordance with the HFP performed by the communication unit 530 is invalidated under the control by the controller 540. When the communication session is triggered by an incoming call directed to the smartphone 200, the controller 540 hands over the incoming call to the smartphone 200. This makes it possible to transmit the input voice data acquired by the HMD 100 to the smartphone 200 smoothly and to avoid a situation that is not necessarily desirable as with a response to the incoming call in the HMD 100.

### (2-3. Example of Communication Session)

An example of the communication session in the present embodiment is described with reference to FIGS. 5 and 6. In the following examples, the functional configuration for communication control by the HMD 100 described above is regarded as being implemented in the control unit 160 of the HMD 100.

FIG. 5 is a sequence diagram showing an example of the communication session when the HMD 100 acquires a voice input. Referring to FIG. 5, in the control unit 160 of the HMD 100, the input voice data acquisition unit 510 (the processor 162, and this is similarly applied to the controller 540 or the like) acquires input voice data from the microphone 172 (S101). As described above, in this case, the input voice data acquisition unit 510 acquires the input voice data while a predetermined user operation (e.g., depression of the PTT key included in the input key 168) which is acquired by the operation unit 550 is performed.

In this case, the controller 540 controls the communication unit 530 (the communication device 166) so that the communication unit 530 may set up a communication session with the smartphone 200 in accordance with the HFP. More specifically, the communication unit 530 transmits a command used to initiate the communication session to the smartphone 200 (S103). This command includes one or a plurality of commands that are prepared to allow the hands-free unit to initiate a voice dial (Voice Dial ON) in the HFP. The communication device 206 of the smartphone 200 establishes a synchronous connection-oriented (SCO) link in response to the command (SCO ON in S105).

When the SCO link is established, the input voice data acquired by the HMD 100 is transmitted to the smartphone 200, and output voice data to be provided in the HMD 100 is received from the smartphone 200 (S107). In other words, in this state, the HMD 100 functions as a voice input and output means of the smartphone 200. In S107, there is no voice data to be transmitted from the smartphone 200, and thus, in practice, the HMD 100 transmits voice data to the smartphone 200 in a unilateral way.

The controller 540 controls the communication unit 530 so that the communication unit 530 establishes the SCO link in parallel with the acquisition of the input voice data by the input voice data acquisition unit 510 as an example, thereby transmitting the acquired input voice data to the smartphone 200 sequentially. Alternatively, the controller 540 may control the communication unit 530 so that the communication unit 530 establishes the SCO link after the acquisition of the input voice data by the input voice data acquisition unit 510 is completed, thereby transmitting the buffered input voice data to the smartphone 200.

When the transmission of the input voice data (S107) is completed, the controller 540 controls the communication unit 530 so that the communication session between the smartphone 200 and the communication unit 530 is terminated. More specifically, the communication unit 530 transmits a command used to terminate the communication session to the smartphone 200 (S109). This command includes one or a plurality of commands that are prepared to allow the hands-free unit to terminate voice dial (Voice Dial OFF) in the HFP. The communication device 206 of the smartphone 200 releases the SCO link in response to the command (SCO OFF in S111).

FIG. 6 is a sequence diagram showing an example of the communication session when there is an incoming call in the smartphone 200. Referring to FIG. 6, a call is incoming from another telephone or information processing terminal to the communication device 208 of the smartphone 200 (S201). In this case, the processor 202 controls the communication device 206 so that the communication device 206 may set up a communication session with the HMD 100 in accordance with the HFP. More specifically, the communication device 206 establishes an SCO link (SCO ON in S203), and transmits a command for notifying the incoming call to the HMD 100 (S205). This command includes one or a plurality of commands that are prepared to notify the incoming call to the hands-free unit in the HFP.

On the other hand, in the control unit 160 of the HMD 100, the communication unit 530 (the communication device 166) receives the command for notifying the incoming call transmitted in step S205. The controller 540 detects that the communication session is triggered by the smartphone 200 and determines whether to invalidate the communication session (S207). The controller 540 may perform the determination on the basis of the setting information stored in the memory 164 as an example, may perform the determination in accordance with the user operation acquired by the operation unit 550, or may perform the determination on the basis of the information acquired by the behavior information acquisition unit 570 or the situation information acquisition unit 580. In the illustrated example, the determination of whether to invalidate the communication session is regarded as being performed by the controller 540.

Then, the controller 540 controls the communication unit 530 so that the communication unit 530 transmits a command for handing over the incoming call to the smartphone 200 (S209). This command includes one or a plurality of commands that are prepared to allow the hands-free unit to hand over the call to the audio gateway in the HFP. The communication device 206 of the smartphone 200 releases the SCO link in response to the command (SCO OFF in S211).

The communication performed in the entire system including the communication session as mentioned above is described with reference to FIG. 7.

FIG. 7 is a sequence diagram showing an example of the communication session in the system according to one embodiment of the present disclosure. Referring to FIG. 7, the control unit 160 of the HMD 100 acquires a voice input using the microphone 172 or the like (S301). In the illustrated example, the input voice data to be acquired contains a spoken voice of the user. The processor 162 transmits the input voice data to the smartphone 200 through the communication device 166 (S303). In this step, the communication session as described with reference to FIG. 5 is performed.

In the smartphone 200, the processor 202 analyzes the input voice data received through the communication device 206 from the HMD 100 and specifies a request indicated by the spoken voice (S305). The request includes a command for feature calling, a designation of search keywords, an input of text, or the like. Furthermore, the processor 202 generates data for an image to be provided later in the HMD 100 on the basis of the request (S307). In this step, although not shown, the processor 202 may communicate with the server 300 through the communication device 208 to analyze the input voice data (voice recognition) or to generate data.

Then, the processor 202 transmits data, which is used to generate image data to be subsequently provided to the HMD 100, such as an icon or text, to the HMD 100 through the communication device 206 (S309). The processor 162 of the HMD 100 generates the image to be displayed next (frame image) based on the information from the smartphone 200 received through the communication device 166 (S311). Further, the processor 162 controls the light source 112 of the display unit 110 based on data of the generated frame image, and thereby updates a frame of an image provided with image display light emitted from the light source 112 (S313).

(3. Hardware configuration)

Next, a hardware configuration of an electronic apparatus according to an embodiment of the present disclosure will be described with reference to FIG. 8. FIG. 8 is a block diagram showing an example of the hardware configuration of the electronic apparatus according to the embodiment of the present disclosure. The illustrated electronic apparatus 900 can realize, for example, the HMD 100, the smartphone 200, and/or the server devices constituting the server 300 of the above-described embodiments. apparatus 900 includes a CPU (Central Processing Unit) 901, a ROM (Read Only Memory) 903, and a RAM (Random Access Memory) 905. In addition, the electronic apparatus 900 may include a host bus 907, a bridge 909, an external bus 911, an interface 913, an input device 915, an output device 917, a storage device 919, a drive 921, a connection port 923, and a communication device 925. Further, the electronic apparatus 900 may include an imaging device 933 and a sensor 935 as necessary. The electronic apparatus 900 may include a processing circuit such as a DSP (Digital Signal Processor) or ASIC (Application Specific Integrated Circuit), alternatively or in addition to the CPU 901.

The CPU 901 serves as an operation processor and a controller, and controls all or some operations in the electronic apparatus 900 in accordance with various programs recorded in the ROM 903, the RAM 905, the storage device 919 or a removable recording medium 927. The ROM 903 stores programs and operation parameters which are used by the CPU 901. The RAM 905 temporarily stores program which are used in the execution of the CPU 901 and parameters which are appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input device 915 is a device which is operated by a user, such as a mouse, a keyboard, a touch panel, buttons, switches and a lever. The input device 915 may be, for example, a remote control unit using infrared light or other radio waves, or may be an external connection device 929 such as a portable phone operable in response to the operation of the electronic apparatus 900. Furthermore, the input device 915 includes an input control circuit which generates an input signal on the basis of the information which is input by a user and outputs the input signal to the CPU 901. By operating the input device 915, a user can input various types of data to the electronic apparatus 900 or issue instructions for causing the electronic apparatus 900 to perform a processing operation.

The output device 917 includes a device capable of visually or audibly notifying the user of acquired information. The output device 917 may include a display device such as an LCD (Liquid Crystal Display), a PDP (Plasma Display Panel), and an organic EL (Electro-Luminescence) displays, an audio output device such as a speaker or a headphone, and a peripheral device such as a printer. The output device 917 may output the results obtained from the process of the electronic apparatus 900 in a form of a video such as text or an image, and an audio such as voice or sound.

The storage device 919 is a device for data storage which is configured as an example of a storage unit of the electronic apparatus 900. The storage device 919 includes, for example, a magnetic storage device such as a HDD (Hard Disk Drive), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the electronic apparatus 900 or attached externally thereto. The drive 921 reads information recorded in the removable recording medium 927 attached thereto, and outputs the read information to the RAM 905. Further, the drive 921 writes in the removable recording medium 927 attached thereto.

The connection port 923 is a port used to directly connect devices to the electronic apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (registered trademark) (High-Definition Multimedia Interface) port, and so on. The connection of the external connection device 929 to the connection port 923 makes it possible to exchange various data between the electronic apparatus 900 and the external connection device 929.

The communication device 925 is, for example, a communication interface including a communication device or the like for connection to a communication network 931. The communication device 925 may be, for example, a communication card for a wired or wireless LAN (Local Area Network), Bluetooth (registered trademark), WUSB (Wireless USB) or the like. In addition, the communication device 925 may be a router for optical communication, a router for ADSL (Asymmetric Digital Subscriber Line), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

The imaging device 933 is a device that generates an image by imaging a real space using an image sensor such as a charge-coupled device (CCD) or a complementary metal-oxide-semiconductor (CMOS) sensor, as well as various members such as one or more lenses for controlling the formation of a subject image on the image sensor, for example. The imaging device 933 may be a device that takes still images, and may also be a device that takes moving images.

The sensor 935 is any of various sensors such as an acceleration sensor, a gyro sensor, a geomagnetic sensor, an optical sensor, or a sound sensor, for example. The sensor 935 acquires information regarding the state of the electronic apparatus 900, such as the orientation of the case of the electronic apparatus 900, as well as information regarding the environment surrounding the electronic apparatus 900, such as the brightness or noise surrounding the electronic apparatus 900, for example. The sensor 935 may also include a Global Positioning System (GPS) sensor that receives GPS signals and measures the latitude, longitude, and altitude of the apparatus.

The foregoing thus illustrates an exemplary hardware configuration of the electronic apparatus 900. Each of the above components may be realized using general-purpose members, but may also be realized in hardware specialized in the function of each component. Such a configuration may also be modified as appropriate according to the technological level at the time of the implementation.

### (4. Supplement)

The embodiments of the present disclosure may include the electronic apparatus, the system, the method executed in the electronic apparatus or the system, the program for causing the electronic apparatus to function, and the non-transitory tangible media having the program recorded thereon, which have been described above, for example.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

The effects described in the specification are just explanatory or exemplary effects, and are not limiting. That is, the technology according to the present disclosure can exhibit other effects that are apparent to a person skilled in the art from the descriptions in the specification, along with the above effects or instead of the above effects.

Additionally, the present technology may also be configured as below.

(1)

A wearable device including:

a voice input unit;

a voice output unit;

an input voice data acquisition unit configured to acquire input voice data from the voice input unit;

an output voice data providing unit configured to provide output voice data to the voice output unit;

a communication unit configured to perform communication sessions for allowing the input voice data and the output voice data to be transmitted and received in accordance with a hands-free profile between the communication unit and an external device; and

a controller configured to invalidate a session triggered by the external device among the communication sessions.

(2)

The wearable device according to (1),

wherein the external device has a calling feature, and

wherein the controller invalidates a session triggered by an incoming call to the external device among the communication sessions and hands over the incoming call to the external device.

(3)

The wearable device according to (1) or (2), further including:

a behavior information acquisition unit configured to acquire information indicating a behavior state of a user of the wearable device,

wherein the controller determines whether to invalidate the session triggered by the external device on a basis of the behavior state.

(4)

The wearable device according to any one of (1) to (3), further including:

a situation information acquisition unit configured to acquire information indicating a situation surrounding the wearable device,

wherein the controller determines whether to invalidate the session triggered by the external device on a basis of the surrounding situation.

(5)

The wearable device according to any one of (1) to (4), further including:

an operation unit configured to acquire a user operation,

wherein the controller determines whether to invalidate the session triggered by the external device on a basis of the user operation.

(6)

The wearable device according to any one of (1) to (5),

wherein the communication unit receives setting information of the wearable device from the external device, and

wherein the controller determines whether to invalidate the session triggered by the external device on a basis of the setting information.

(7)

The wearable device according to any one of (1) to (6), further including:

an image providing unit configured to provide image data to a light source of the wearable device, the light source being configured to emit light used to allow a user to perceive an image,

wherein the communication unit further performs a communication session for receiving data used to generate the image data from the external device.

(8)

The wearable device according to (7),

wherein the input voice data includes a spoken voice of the user, and

wherein the communication unit transmits the input voice data to the external device in accordance with the hands-free profile and receives data used to generate the image data from the external device, the data used to generate the image data being generated in response to a request indicated by the spoken voice.

(9)

The wearable device according to (7) or (8),

wherein the wearable device includes a first unit having the light source and a second unit having the voice input unit and the voice output unit, the first unit being worn on a head of the user, the second unit being separated from the first unit.

(10)

The wearable device according to (9),

wherein the second unit includes at least one of the communication unit and the controller.

(11)

The wearable device according to any one of (1) to (8),

wherein the wearable device is worn on a head of a user.

(12)

The wearable device according to any one of (1) to (8),

wherein the wearable device is attached to a part other than a head of a user.

(13)

A method of controlling communication between a wearable device and an external device, the method including:

performing communication sessions including a transmission of input voice data acquired from a voice input unit of the wearable device to the external device and a reception of output voice data to be provided to a voice output unit of the wearable device from the external device in accordance with a hands-free profile; and

invalidating a session triggered by the external device among the communication sessions.

### REFERENCE SIGNS LIST

10 system
100 HMD
110 display unit
112 light source
114 light guide plate
160 control unit
162 processor
164 memory
166 communication unit
168 input key
170 touch sensor
172 microphone
174 speaker
200 smartphone
202 processor
204 memory
300 server
302 processor
304 memory
510 input voice data acquisition unit
520 output voice data providing unit
530 communication unit
540 controller
550 operation unit
560 image providing unit
570 behavior information acquisition unit
580 situation information acquisition unit

1. A wearable device comprising:
a voice input unit;
a voice output unit;
an input voice data acquisition unit configured to acquire input voice data from the voice input unit;
an output voice data providing unit configured to provide output voice data to the voice output unit;
a communication unit configured to perform communication sessions for allowing the input voice data and the output voice data to be transmitted and received in accordance with a hands-free profile between the communication unit and an external device;
a controller configured to invalidate a session triggered by the external device among the communication sessions; and
a behavior information acquisition unit configured to acquire information indicating a behavior state of a user of the wearable device,
wherein the controller determines whether to invalidate the session triggered by the external device on a basis of the behavior state.

2. The wearable device according to claim 1,
wherein the external device has a calling feature, and
wherein the controller invalidates a session triggered by an incoming call to the external device among the communication sessions and hands over the incoming call to the external device.

3. (canceled)

4. The wearable device according to claim 1, further comprising:
a situation information acquisition unit configured to acquire information indicating a situation surrounding the wearable device,
wherein the controller determines whether to invalidate the session triggered by the external device on a basis of the surrounding situation.

5. The wearable device according to claim 1, further comprising:
an operation unit configured to acquire a user operation,
wherein the controller determines whether to invalidate the session triggered by the external device on a basis of the user operation.

6. The wearable device according to claim 1,
wherein the communication unit receives setting information of the wearable device from the external device, and
wherein the controller determines whether to invalidate the session triggered by the external device on a basis of the setting information.

7. The wearable device according to claim 1, further comprising:
an image providing unit configured to provide image data to a light source of the wearable device, the light source being configured to emit light used to allow a user to perceive an image,
wherein the communication unit further performs a communication session for receiving data used to generate the image data from the external device.

8. The wearable device according to claim 7,
wherein the input voice data includes a spoken voice of the user, and
wherein the communication unit transmits the input voice data to the external device in accordance with the hands-free profile and receives data used to generate the image data from the external device, the data used to generate the image data being generated in response to a request indicated by the spoken voice.

9. The wearable device according to claim 7,
wherein the wearable device includes a first unit having the light source and a second unit having the voice input unit and the voice output unit, the first unit being worn on a head of the user, the second unit being separated from the first unit.

10. The wearable device according to claim 9,
wherein the second unit includes at least one of the communication unit and the controller.

11. The wearable device according to claim 1,
wherein the wearable device is worn on a head of a user.

12. The wearable device according to claim 1,
wherein the wearable device is attached to a part other than a head of a user.

13. A method of controlling communication between a wearable device and an external device, the method comprising:
performing communication sessions including a transmission of input voice data acquired from a voice input unit of the wearable device to the external device and a reception of output voice data to be provided to a voice output unit of the wearable device from the external device in accordance with a hands-free profile;
invalidating a session triggered by the external device among the communication sessions; and
a behavior information acquisition unit configured to acquire information indicating a behavior state of a user of the wearable device,
wherein the invalidating includes determining whether to invalidate the session triggered by the external device on a basis of the behavior state.
